(19) United States
(12) Patent Application Publication
(10) Pub. No.: US 2004/0021889 A1
(43) Pub. Date: Feb. 5, 2004

(54) Method of transmitting information from a document to a remote location, and a computer peripheral device

(76) Inventors: David A. McAfee, Spring, TX (US); Derrill Sturgeon, Spring, TX (US); John C. Barker, Houston, TX (US)

Correspondence Address: SHARP COMFORT & MERRETT, PC, 13355 NOEL ROAD, SUITE 1340, DALLAS, TX, 75240, US

(21) Appl. No.: 10/208,423

(22) Filed: Jul. 30, 2002

(51) Int. Cl. G06F 15/00; H04N 1/00; G06F 11/30; H04L 9/32

(52) U.S. Cl. 358/1.13; 358/402; 358/1.15; 358/407; 713/202

(57) ABSTRACT

A scanner device, e.g. a multi function peripheral device incorporating scan, copy and print functions, and a method of operation, in which the device is user operable to directly establish a communication link with a network server having email receive and transmit functionality, e.g. an internet server, and to transmit to the network server over the transmission link, message header data including at least an email address of a sender and of at least one intended recipient; accompanied by the scanned content of a source document scanned by the device, to the network server for transmission to the or each recipient. No intermediate processor computer processing is involved in transmitting the scanned data from the scanner device to the network server.

### BACKGROUND OF THE INVENTION

Data transmission of information contained in documents by facsimile (fax) has long been a staple means of rapid communication in a business environment and more recently to an increasing extent in a small office/home environment. In addition, use of electronic messaging over the internet, for example by e-mail, has become a popular means of communication. Data stored in a computer file (e.g. a word processor file, database file, or a graphics file, etc.) can be pasted into the body of an electronic message or a copy of the computer file (electronic copy) can be transmitted as an attachment to an electronic message.

A document scanning device, for example a dedicated document scanner, a facsimile machine, or a multi-function printer (MFP) incorporating a scanning functionality, can be used to create an electronic version of an input document by transferring the scanned image(s) to a PC or other (e.g. a laptop or notebook) computer by a suitable communications link, for example a cable or wireless link. An application running on the computer would receive the incoming scanned document, launch a default email application, create a new email message and attach the scanned document to the email. This is typically done using the default Messaging Application Programming Interface (MAPI) client on a PC. Some newer implementations extend this functionality to include support for AOL mail or HTML based mail clients (such as MSN Hotmail) which are not compliant with the MAPI. One problem is that the user must make sure that the PC is turned on when it is desired to use such a fax to email mode, and problems can occur with PCs that enter “sleep” or “hibernate” power conserving states. In these states, situations can occur where the PC will not “wake up” to perform the desired function

U.S. patent application Ser. No. 09/253,192 filed Feb. 19, 1999 by John C. Barker and Montgomery McGraw, and assigned to Compaq Computer Corporation, assignees of the present application, discloses a method and system in which a computer controls various operations of a scanning device, including facsimile transmission and electronic message transmission operational parameter instructions are defined by machine and human readable indicia on an instruction sheet. Desired instructions such as identification of a sender and one or more recipients may be selected by a user making annotations at appropriate locations on the instruction sheet which is then input to the scanning device. The scanning device output can be transferred to the computer for use by the computer to control the transmission process.

A fundamental problem with attaching a scanning device to a PC for such purposes is that two pieces of hardware are required to accomplish a single function. This can be a very costly solution for a consumer or small office user, and it creates a number of engineering complexities which must be overcome.

Another approach has been to install a T.37 data modem into a fax machine or MFP and to configure the data modem device such that it could emulate a PC and dial an Internet Service Provider (ISP) directly. The device would be programmed with the login and authentication information of the user and would send an email directly to the mail server operated by the ISP. This approach typically is more expensive due to the higher cost of a T.37 modem and the need for sufficient memory for the additional firmware and data storage required for emulating an email client. In addition, the ISP chosen for the service must have local Point of Presence (POP) if long distance telephone connection charges are to be avoided

### SUMMARY OF THE INVENTION

In an embodiment of one aspect of the invention, a method of transmitting information from a document to a remote location, comprises effecting user initiated operation of a device having a scanning function to scan content of a source document, operating the device to directly establish a communication link with a network server having email receive and transmit functionality and to transmit to the network server over the transmission link, message header data including at least an email address of a sender and of at least one intended recipient; together with the scanned content of said source document to the network server.

The network server may be operated to transmit an electronic message incorporating said message header and the scanned content of the source document received by the network server from the scanning device, to the or each destination electronic message receiver identified by the associated recipient email address. For example, the electronic message may incorporate the scanned content of the source document as an attachment to the electronic message header or as a MIME attachment to an email message header.

According to another aspect, a computer peripheral device embodiment of the invention comprises a display, a user interface including data input keys and control keys, a scanner operable to create data by scanning a source document, control circuitry, a memory, and a communication interface. The memory includes a storage region for a data sequence for communication with an internet message server and a predetermined first storage area storing a sender's email address. The peripheral device is operable in an email transmission mode in response to operation of one or more of the data input and control keys. When the peripheral device is in the email transmission mode, he control circuitry is operable in conjunction with the memory to activate the display to display input prompts for user entry of data including an email address of at least one recipient and to store the recipient email address in the first storage area. The control circuitry is further operable in conjunction with the memory and the communication interface to retrieve and transmit via the communication interface a data sequence for communication with an internet message server. On establishment of a communication link with the internet message server, email message header data is transmitted via the communication interface to the internet message server by retrieving from the first storage area, the sender's email address and the email address of the or each recipient. After transmission of the message header data, data resulting from scanning a source document by the scanner is transmitted. Desirably, the computer peripheral device may be a multi function printer device incorporating the said scanner.

Advantageously, the display input prompts may include at least one prompt for user authentication data to be entered and stored at a predetermined storage location of the memory; and following establishment of a d communication link with the internet message server, the control circuit is operable to retrieve and transmit to over the communication link, the user authentication data for verification by the internet message server prior to enabling transmission of the message header data.

### BRIEF DESCRIPTION OF THE DRAWINGS

The foregoing and other advantages of the invention will become apparent upon reading the following detailed description and upon reference to the drawings in which:

FIG. 1 is a diagrammatical representation of a system embodying the invention including a scanning device for transmission of scanned documents to a remote network server;

FIG. 2 is a diagrammatical view of certain of the functional components and circuits of the scanning device depicted in FIG. 1;

FIG. 3 is a flow diagram of operations occurring at the scanning device depicted in FIG. 1 to implement transmission of scanned documents; and

FIG. 4 is a diagram of e-mail receiver equipment; and

FIG. 5 depicts the layout of an instruction cover sheet suitable for use in an alternative embodiment of the invention.

### DETAILED DESCRIPTION OF EMBODIMENTS OF THE INVENTION

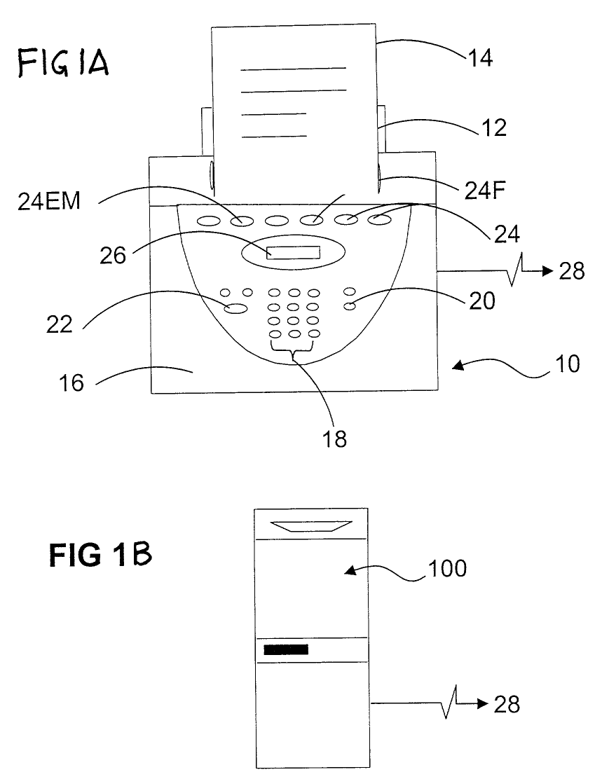

FIG. 1 depicts a multi functional printer (MFP) 10 which incorporates printer, copier, scanner, and facsimile transmission/reception functionalities. The MFP 10 is configured to scan input documents and to transmit the scanned information using conventional facsimile transmission procedures. In addition, in accordance with an embodiment of the present invention, the MFP 10 is configured for selective operation in an email mode to transmit email header data and scanned (or stored) information from the MFP 10 directly to a remote network electronic message (email) server 100 operated by an Internet Service Provider (ISP). In this mode of operation, need for the use of an attached PC in the communication link between the MFP 10 and the email server is obviated. The MFP 10 may, for example, be a Model A1500 All-in-One-Printer sold by Compaq Computer Corporation, incorporating printer, copier, scanner, and facsimile transmit/receive functionalities, and modified in accordance with the invention to incorporate the functionality required to compose and transmit email header and message data directly to a network email server.

As illustrated in FIG. 1, the MFP 10 includes a document feed tray 12 in which an input document 14 can be positioned for scanning of data or information or other indicia on the document. The MFP 10 further includes an interface panel 16 on which a series of input and control buttons or keys are accessible for user actuation. Such keys may include conventional alpha and digit input keys 18, special command keys 20 (e.g. for speed dialing), a START (SEND) key 22 to initiate a transmit routine, as well as special function mode keys 24 for controlling execution of such operations as scanning, copying, facsimile transmission, control form input, and so forth. The input keys 18 correspond in functionality and layout to those typically incorporated in a fax machine, including numeric keys for entering digits 0-9, *, and # symbols and in which each of the numeric keys 2-9 also can be actuated for selective entry of multiple alpha characters. For example, the digit key “2” also can be selectively operated to enter an “A”, “B” or “C” by actuation of the key until the required character appears on the display 26, in a manner widely used in operation of cell phones. A separate key would be required to manually move to the next field in situations where user input of two consecutive letters using the same numeric key (e.g. “AB”) is necessary. The “@” symbol used in email addresses may be input by using a specially programmed key or concurrent operation of a pre-selected plurality of keys on the user interface panel 16. Also, key programming would be included to permit manual input of other email characters commonly permitted in emails, for example and underscore (“_”), and a hyphen (“-”).

Actuation of one of the mode keys, 24EM, places the MFP 10 in direct e-mail transmit mode to be described in more detail below. The mode keys 24 may be preprogrammed (dedicated) or user programmable. Alternatively, instead of using a mode key 24EM for email mode access, the MFP 10 can be programmed to enable concurrent actuation of two selected keys (e.g. the “START” key 22 and the key 18 representing an asterisk “*”. (Subsequent reference herein to the email function mode key 24EM applies equally to the alternative embodiment utilizing concurrently operable keys and operation thereof in connection with the email mode of operation of the MFP 10.) Various text or graphics messages can be displayed for a user on a read-out display 26 on the interface panel 16.

The MFP 10 is operable to transmit and receive data via a transmission link 28 to and from the email server 100, as well as to other destination devices, e.g. conventional facsimile devices.

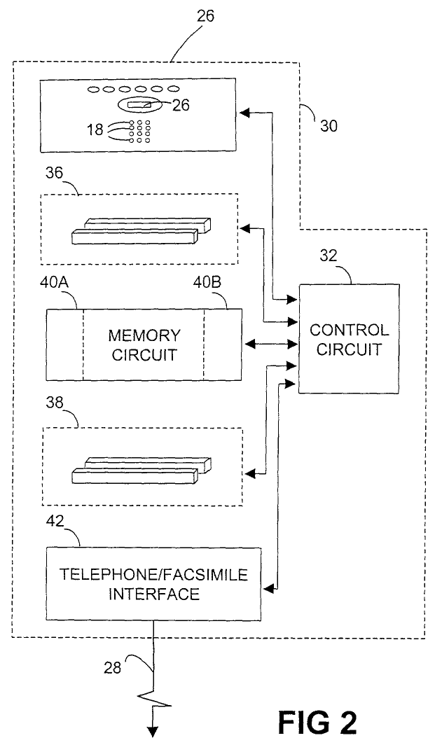

FIG. 2 diagrammatically illustrates certain of the functional circuitry and components 30 of the MFP 10. The MFP 10 may include a wide array of known functional circuits and hardware, depending upon its particular design. In the illustrated embodiment the MFP 10 includes a control circuit 32 which is configured to execute programming code for independently controlling the operation of the various sub-circuits and components of the device. The control circuit 32 is functionally coupled to the various keys 18, 20, 22, 24 on the user interface panel 16 as well as to the display 26 for receiving user-generated commands and for displaying messages to a user. The MFP 10 incorporates a scanning head 36 operable to digitize data and information indicia (including textual and graphical data) on input documents 14 fed into the MFP 10. As will be appreciated by those skilled in the art, the scanning head 36 may be designed for either black-and-white scanning or for color scanning, or both. In general, such devices emit radiation to the surface of a document and detect reflections from the surface, encoding contrasting wavelengths differently to generate digital output data. The data is transmitted from scanning head 36 to the control circuit 32 which enters the scanned data into a memory circuit 40 for temporary storage prior to transmission. A print head 38 is coupled to the control circuit 32 to permit digitized data to be output for printing on a document in a print feed (not shown) of the MFP 10.

The MFP 10 also incorporates a telephone/facsimile interface circuit 42 coupled to the transmission link 28 for sending and receiving data in facsimile format under control of the control circuit 32. The control circuit 32 is also coupled to the memory circuit 40 which stores data, including programming code executed by the control circuit 32 for carrying out various functions in operation of the MFP in its various operational modes in known manner. For example, the memory circuit 40 stores operational parameters employed by the device in scanning documents, printing documents, transmitting digitized data using facsimile procedures as well as storing dialing data sequences for user recall, by operation of one of the speed dial keys 20 together with one or more of the input keys 18 and in conjunction with the display 26, to automatically control “speed dialing” access to destination devices. The control circuit 32 is, in particular, programmed to store in the memory 36 special email address dial sequences for transmission to the email server 100 in implementing the present invention, as will be described below.

The MFP 10 can receive instructions for its operation in one of several manners. Actuation of a function mode key 24 enables operation of the MFP 10 in a corresponding one of its various functional modes, e.g. copy, print, scan, fax, email. Control and data inputs can be formulated by acuating appropriate input keys 18 and/or command input keys 20 on the interface panel 16. As keys controlling various functions are actuated, signals are transmitted to the control circuit 32 for executing the corresponding function(s), typically by reference to program code and data stored by the memory circuit 40. Also, the function and input keys can be user actuated to store special function instructions in the memory 40 and to associate those instructions with actuation of particular keys or key combinations to implement the corresponding stored instruction or to access the corresponding stored data.

To implement one embodiment of the invention, the MFP 10 incorporates the following features.

The memory 40 has a designated storage location 40A storing a data sequence necessary to establish dial up access to an email server 100 when the MFP 10 is in the email mode (mode key 24EM enabled). (Data sequences for dial up access of other internet provider servers may also be stored at individual locations in the memory 40 and could be implemented by actuation of the mode key 24EM and a designated one of the keys 18). This data sequence is read and transmitted over the communications link 28 when the START key is actuated following composition of an email message header as described below.

The memory 40 also has a designated storage region 40B for entry of message header data, when an email is being composed, including User Account or Log On data (typically User Identification and Password (PIN))—if required, email recipient address(es), copy recipient address(es), and “Subject” data. These data may be retrieved from other memory locations in the memory 40 or entered manually using appropriate keys on the interface panel 16 during an email message composition procedure. Recipient e-mail addresses may be stored in an “address book” in the memory 40 for recall and entry into the email header using known techniques similar to those for storage and retrieval of dialing data sequences. To create an address book, a user may enter the necessary data sequence using input keys 18 (including the key(s) required to enter the “@” symbol) and associate each data sequence representing an email address with a designated “email speed dial” memory location identifier, e.g. a number in the range 0-99, accessed in conjunction with actuation of a speed dial key 20. The data keys 18 are combination alpha/numeric keys with actuation of each key causing entry of its associated numeric character or one of the associated alpha characters according to the manner of actuation as described above. Thus, the numeric key “2” can be actuated to enter a numeric “2” or any of the associated alpha characters “A”, “B” or “C”.

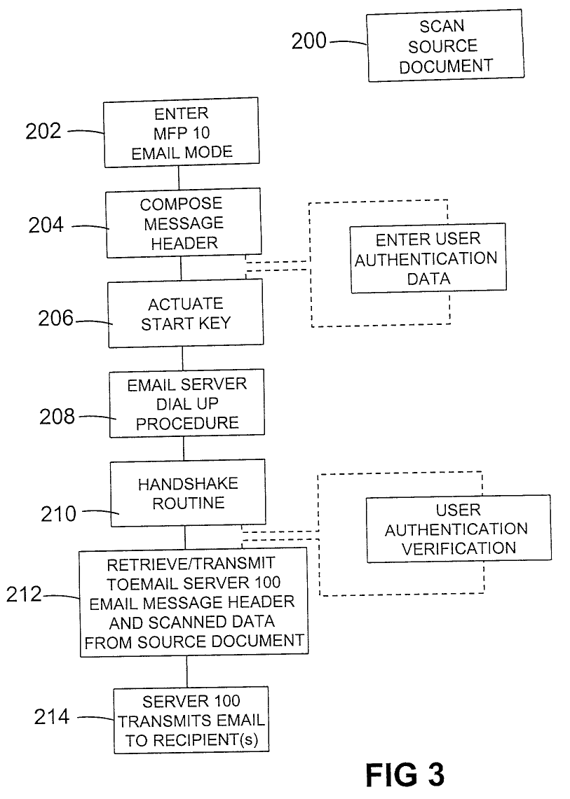

The control circuit 32 also is programmed or otherwise modified to implement the email composition and transmit procedure to be described below with reference to FIG. 3.

To compose and transmit an email message, using typical email procedures, a user inserts a document 14 containing information (text and/or graphics) into the document feed tray 12 of the MFP (step 200) and places the MFP 10 in an email mode at step 202 in FIG. 3 by actuating the email mode key 24EM. In response, the control circuit 32 interacts with the memory 40 to display a Header Prompt Menu which may be displayed one line at a time and scrolled up or down to the next line in response to user data entry (step 204). The Header Prompt Menu may have the following format, the displayed prompts being shown in regular font, and exemplary data entries in italics:

| | |
|---|---|
| User Account No: | JD12345* |
| PIN: | 56AB78* |
| To: | johndoe@acme.com* |
| To: | jimsmith@home.com** |
| cc: | jane doe@widget.com** |
| Subject: | INFORMATION MEMO |

In step 204, the user inserts the pertinent User Account Identification data and Password (or PIN) using appropriate keys 18, etc. on the user interface panel 16, entering a control character, e.g. an asterisk (*) following completion of the data on each line, which causes the display to scroll to the next line. Alternatively, the data may be retrieved from the memory 40 by actuation of appropriate user interface panel keys (e.g. using character matching techniques to cause display of complete data strings in response to user entry of initial data string characters), or by a combination of both data entry procedures. The user then enters in the appropriate displayed Header Prompt Menu fields the email address of each recipient (either manually or by retrieval from the stored “address book”) entering an asterisk at the end of each address to cause scroll to a blank address entry field, and after entry of the final address, enters a sequence of two asterisks (**). The same procedure is followed for entry of copy recipients. Then the display scrolls to a Subject field for user entry of data appropriate to the subject matter of the email message. The Header Menu may also include prompts for entry of other data or instructions, e.g. encryption, message signature, return receipt, using known procedures. The entered data displayed in the Header Prompt Menu is stored in appropriate locations of the HEADER storage location 40B of the memory 40. Following entry of the Subject data, at step 206, the user actuates the START key on the interface panel 16 which initiates retrieval by the control circuit 32 from the memory 40 of the email server dial up data sequence from the memory area 40A and transmission of that data sequence via the Telephone/Facsimile interface 42 to the email server 100 over the communication link 28 (Step 208).

In response to receipt of the dial up data sequence, the email server 100 and the MFP 10 carry out standard handshake procedures to establish a communication link between them (Step 210). Then, the MFP 10 retrieves from the memory region 40B and transmits the User Account Information and Password data over the communication link 28 to the email server 100 where it is compared with valid User Account Identification and associated Password data stored at the email server 100. If the transmitted and stored data do not match, an error message is transmitted from the email server 100 back to the MFP 10 and displayed on the display panel 26, and absent connection and transmission of a valid User Account and Password data, the communication link is dropped after a predetermined delay. Validation of the User Account and Password data at the email server 100, is transmitted back to the MFP 10 and in response, at step 212, the control circuit 32 initiates retrieval of the recipient and copy recipient email addresses and the Subject data from the storage region 40B of the memory 40 and adds to the message header data the sender's email address data together with any other data typically transmitted as part of an email header, e.g. time and date of transmission, and transmits the complete header data directly to the email server 100 over the interface 42 and the communication link 28. Transmission of the email header data is then followed by transmission of data resulting from scanning of the document 14. The scanned data (step 200) can be generated immediately following transmission of the message header data in step 212 or may be retrieved from the memory 40, having been entered by initiation of the scanning process (step 200) on actuation of the START key following entry of the message header data in response to the Header Prompt Menu. The scanned data is appended to the transmitted header data using standard MIME (Multipurpose Internet Mail Extensions).

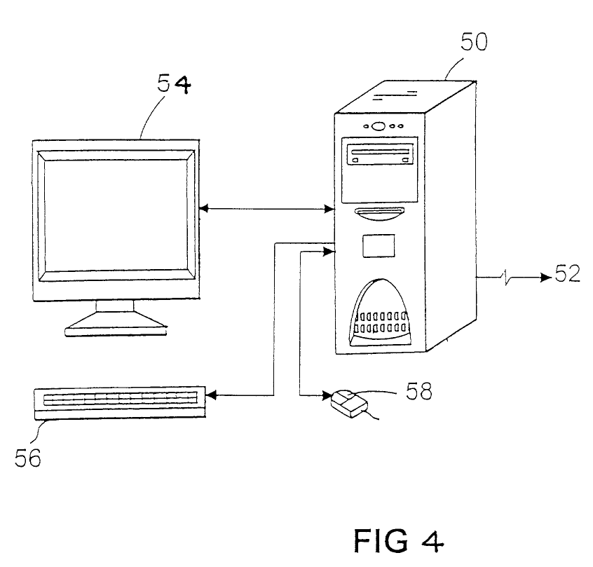

Once the MFP 10 has completed the send process to the email server 100, and drops the line, the network server 100 processes the email address information in known manner to forward the message header and scanned data over the internet to the or each email recipient address. For example, as indicated in FIG. 4, a remote PC 50 may receive the email message including the scanned data attachment over an internet communication link 52, for retrieval by a user and display on a display monitor 54 connected to the PC 50, under control of inputs from a keyboard 56 and/or a mouse 58.

In a further development of the invention, the email server 100 could be programmed to store corresponding to the email addresses stored at associated speed send memory locations (typically identified by two or three digits) in the MFP 10 such that they can be synchronized by the MFP 10 with corresponding speed send addresses stored by the server 100. The MFP 10 then would need only to transmit to the email server 100, identification of the corresponding Speed Send memory location of the email addresses of the or each recipient instead of the complete address. Further, instead of synchronizing off-line, the email server 100 and the MFP 10 could both incorporate a time/date stamp, checksum or flag associated with the email address list stored at each location. This would permit the MFP 10 to dial the email server 100 to initiate an email transmit transaction, and to transmit its current address list (including any new email addresses and memory location identifiers, and any updates to existing stored email addresses) and synchronize with the email server 100 prior to sending any messages, thus ensuring the email message(s) are correctly sent to the intended recipients.

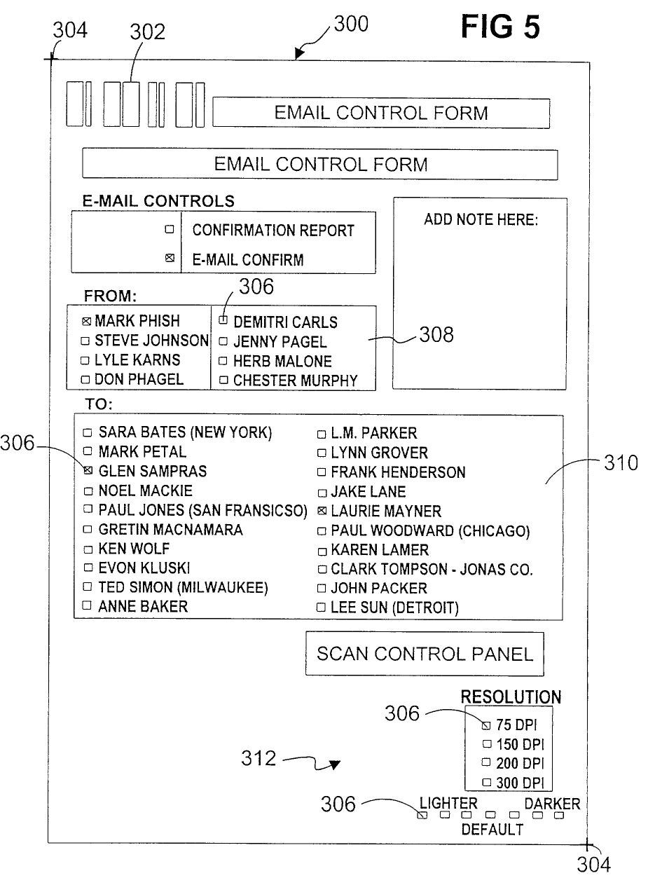

U.S. patent application Ser. No. 09/253,192 filed Feb. 19, 1999 by John C. Barker and Montgomery McGraw, and assigned to Compaq Computer Corporation, assignees of the present application, discloses a method and system in which a computer controls various operations of a scanning device, including electronic message transmission and the disclosure of that application is hereby fully incorporated by reference into the present application. In patent application Ser. No. 09/253,192 operational and functional parameter instructions are defined by machine and human readable indicia on an instruction sheet, an example of which is depicted in FIG. 5, which may be associated with (e.g. immediately precede in the scanning operation) a document containing information to be transmitted. The control form 300 includes a control field 302 incorporating coded markings identifying, when scanned by the MFP 10, that the control form represents instructions to be applied in connection with composing and sending an email message. The control form also includes reference markers 304 at predetermined opposite diagonal margin locations on the control form. The control form incorporates small open rectangular marker areas 306 at known locations relative to the reference markers 304. Desired instructions may be indicated by a user placing ea mark (e.g. an “X”) in the or each marker area 306 associated with a function or operation to be carried out by the MFP 10 in response to scanning of the control form. Alternatively, pertinent rectangles could be filled in. Marker areas 306 in the region 308 are associated with names of senders of an email message and marker areas 306 in the region 310 are associated with names of prospective email recipients. Marker areas 306 in the region 312 are associated with operational parameters of the scanner function of the MFP 10 to control scanning of a document following scanning of the control form 300. Actuation of the Control Form key 24CF followed by operation of the START key then initiates scanning of the control form 300 (which is fed as an input document 14 into the feeder tray 22), transfers data identifying the locations of the scanned marker areas that have been marked as indicated above, to data sets corresponding to the associated functions (e.g. senders name and email address; recipient's name(s) and email address(es)) on the basis of which the MFP10 references the corresponding data from the memory 40 and enters the data into storage region 40B for incorporation into email message headers, or otherwise appropriately associates the pertinent data with composition and/or transmission of an email message generated by scanning of a document following scanning of the control form. The control form process described above can be further modified to enable processing of the information on the Control Form on the remote server 50, instead of being processed locally by the MFP 10. This would have the advantage of allowing the use of a standard fax machine to transmit the necessary information to the remote fax server.

A remote fax server could be used instead of the email server 50, modified to recognize receipt of an email dial up number from a call in device, such as an MFP, and respond an email address transmitted as a DTMF sequence from the MFP by composing an email header, attaching to it the content of a documents scanned at the MFP and transmitted as a fax document for appending to the email header by the remote server, prior to transmission to the or each recipient using normal email transmission procedures. Communication between the MFP and the remote server would be established using a special dialed up access number and a conventional facsimile transmission handshake process. The server would recognize the special email access number and switch into a mode in which it would recognize a stream of DTMF tones. If required, the initial sequence of DTMF tones would communicate user ID and PIN information from the MFP and acknowledgment from the server. The typical email message header information (recipients email address(es), senders email address, and subject would then be transmitted by DTMF tones from the MFP to the server by manually inputting the data or could be retrieved from storage at the MFP and transmitted using known procedures. The DTMF tones representing the email header data in this embodiment are composed by converting each alpha character and symbol into a corresponding three-digit octal numeric representation of the associated ASCII code. Consecutive email addresses are separated by a suitable character (e.g. “#”) and an “end of list” character (e.g. “##”) follows the final recipient's email address. On receipt of the email header data, the server initiates a standard facsimile handshake process with the MFP which transmits the information content of a scanned document an d the server appends that data to the email header as a conventional MIME attachment, pror to transmission to the or each email recipient using conventional procedures. Modification of a fax server to operate in this manner may be accomplished using normal programming procedures.

While preferred embodiments of a method of transmitting information from a document to a remote location and computer peripheral device suitable for use in implementing the method have been disclosed, it will be apparent to those skilled in the art that the invention can be modified in both configuration and detail. Therefore, the scope and protection afforded the invention should only be limited in accordance with the scope of the following claims.

1. A method of transmitting information from a document to a remote location, comprising the steps of:
effecting user initiated operation of a device having a scanning function to scan content of a source document;
operating the device to directly establish a communication link with a network server having email receive and transmit functionality and to transmit to the network server over the transmission link, message header data including at least an email address of a sender and of at least one intended recipient; together with the scanned content of said source document to the network server.

2. A method according to claim 1, further including the step of operating the network server to transmit an electronic message incorporating said message header and the scanned content of the source document received by the network server from the scanning device, to the or each destination electronic message receiver identified by the associated recipient email address.

3. A method according to claim 1, wherein the electronic message incorporates the scanned content of the source document as an attachment to the electronic message header.

4. A method according to claim 1, wherein the scanned information is transmitted by the network server as a MIME attachment to an email message header.

5. A method according to claim 1, wherein the data identifying a sender comprises an email address of the sender.

6. A method according to claim 1, wherein said device includes stored data representing a sender's email address and representing email addresses of a plurality of prospective recipients, and at least part of said message header is composed by selective retrieval of said stored data.

7. A method according to claim 6, wherein said stored data representing sender and recipient email addresses are associated with an individual storage location identifiers and can be synchronized over said data transmission link with corresponding data and individual storage location identifiers stored by said server, wherein operation of said device to transmit to the network server, data identifying a sender and the electronic mail address of at least one intended recipient, transmits the individual storage location identifiers associated with said sender and the or each intended recipient; and
wherein said network server responds to reception of said transmitted storage location identifiers by retrieval of the corresponding data identifying the sender and the electronic message address of the or each intended recipient from said data stored by the network server.

8. A method of effecting a transaction to transmit information obtained by scanning a source document, directly from a computer peripheral device to a remote location, said peripheral device including a display and a memory, comprising the steps of:
composing and storing at a first location of said memory, user authentication data and electronic message header data in response to menu prompts displayed by said display, said message header data including at least one recipient email address data of at least one recipient;
operating the peripheral device to establish a communication link with a network electronic message server; wherein
in response to establishment of said communication link, said peripheral device retrieves from said first memory location and transmits to said electronic message server, said user authentication data for verification; and
in response to verification of said user authentication data, said peripheral device retrieves from said first memory location and transmits directly to said electronic message server over said communication link, the retrieved message header data and a sender's email address followed by said scanned source document data.

9. A method according to claim 8, wherein said source document is scanned by a scanning function of said peripheral device.

10. A method according to claim 8, wherein said peripheral device incorporates facsimile transmit and receive functionality and wherein said scanned source document information is stored in said peripheral device memory from a received facsimile communication to said peripheral device.

11. A method according to claim 8, wherein said peripheral device memory stores email address data of a plurality of prospective email recipients and wherein said message header data is composed by either or both (a) manual data entry using said input and control keys or (b) retrieval from said stored email addresses.

12. A method according to claim 8, wherein said menu prompts include a prompt for input of a subject heading in said message header data.

13. A method according to claim 12, wherein said data representing the electronic mail address of a sender is automatically selected by said scanning device from a default storage location of said peripheral device memory.

14. A computer peripheral device comprising a display, a user interface including data input keys and control keys, a scanner, control circuitry, a memory, and a communication interface:
said scanner operable to create data by scanning a source document;
said memory including a storage area for a data sequence for communication with an internet message server; said memory including a predetermined first storage area storing a sender's email address;
said peripheral device operable in an email transmission mode in response to operation of one or more of said data input and control keys;
with said peripheral device in said email transmission mode, said control circuit operable in conjunction with said memory to activate said display to display input prompts for user entry of data including an email address of at least one recipient and to store said recipient email address in said first storage area;
said control circuit further operable in conjunction with said memory and said communication interface to retrieve and transmit via said communication interface data sequence for communication with an internet message server and also operable in response to establishment of a communication link with said internet message server to transmit email message header data via said communication interface to said internet message server by retrieving from said first storage area, said sender's email address and the email address of the or each recipient, and after transmission of said message header data to transmit data resulting from scanning a source document by said scanner.

15. A computer peripheral device according to claim 14, wherein said display input prompts includes at least one prompt for user authentication data to be entered and stored at a predetermined storage location of said memory; and wherein following establishment of a said communication link with said internet message server, said control circuit is operable to retrieve and transmit to over said communication link, said user authentication data for verification by said internet message server prior to enabling transmission of said message header data.

16. A computer peripheral device according to claim 14, wherein the computer peripheral device is a multi function printer device incorporating printer, copier, and facsimile transmit and receive functionality in addition to said scanner.
